(19) United States
(12) Patent Application Publication
(10) Pub. No.: US 2007/0103951 A1
(43) Pub. Date: May 10, 2007

(54) Power converter apparatus

(75) Inventors: Katsumi Ishikawa, Hitachinaka (JP); Hideki Miyazaki, Hitachi (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi, Ltd., Chiyoda-ku (JP)

(21) Appl. No.: 11/593,477

(22) Filed: Nov. 7, 2006

(30) Foreign Application Priority Data
Nov. 8, 2005 (JP) 2005-323005

(51) Int. Cl. H02M 1/00

(52) U.S. Cl. 363/146

(57) ABSTRACT

In a power conversion apparatus having a smoothing capacitor for smoothing rectified voltage, a power module containing a plurality of power semiconductor switching devices, and a drive circuit for controlling the turn-on and turn-off of the power semiconductor switching devices, wherein the power module is encased in the housing which does not encase the drive circuit; the housing encasing the power module therein is attached in contact with the housing encasing therein the transmission of an prime mover.

### BACKGROUND OF THE INVENTION

This invention relates to a power conversion apparatus comprising a smoothing capacitor for smoothing rectified voltage, a power module containing a plurality of switching devices operable at high temperatures, and a drive circuit for controlling the turn-on and turn-off of the switching devices.

The upper limit of temperature at which the IGBT module used in an IGBT inverter incorporating silicon (Si) semiconductor devices therein can operate reliably, is around 125 degrees centigrade (125° C.). As compared with such a silicon semiconductor device, power semiconductor devices using SiC (silicon carbide), GaN (gallium nitride) or diamond as their semiconductor substrates are known as operable at temperatures higher than the temperature upper limit for the silicon semiconductor device. The Japanese patent document, JP-A-10-294471 (paragraphs [0015] through [0018]), discloses a junction type SiC transistor having no gate oxide layer. Since this junction type SiC transistor is a power device which does not uses a gate oxide layer, it can be operated at relatively higher temperatures. On the other hand, around 125 degrees centigrade (125° C.) is the upper limit of temperature at which such parts incorporated in the inverter as the smoothing capacitor for smoothing the rectified voltage or the parts (power transformer and photo-coupler) of the drive circuit for controlling the turn-on and turn-off of switching devices, can operate reliably. If those parts having the temperature upper limit of around 125 degrees centigrade (125° C.) are located within the housing which encases therein power semiconductor devices using SiC, GaN or diamond as their substrates, then the parts may be exposed to temperatures far exceeding the upper limit.

The Japanese patent document, JP-2004-350360 (paragraphs [0022] through [0030]), discloses the provision of the power conversion apparatus wherein the cooling mechanism is simplified by using semiconductor devices having a range of operating temperatures higher than the operating temperatures for ordinary silicon devices, and the parts layout is designed in such a manner that the conduction of heat from the power conversion area to the control area is reduced by separating the former from the latter.

### SUMMARY OF THE INVENTION

SiC devices have an advantage over ordinary Si devices since the former can reliably operate at higher temperatures than the latter. Also, SiC devices are mainly of unipolar type to which junction type SiC devices and MOSFET-SiC devices belong. Unipolar devices are characterized by their very high switching speed. The very high switching speed leads advantageously to very low switching loss (very low power loss in turn-on or turn-off).

However, the unipolar devices, too, have a disadvantage that the surge voltages generated due to the switching action of the inverter are superposed on the output voltage of the inverter. Therefore, the surge voltages are applied to the motor terminals, too. If the surge voltages are high enough, they adversely affect the insulation of the motor windings, thereby degrading the insulation. FIG. 2 graphically shows the relationship between the length of the wiring cables from the output terminals of the inverter to the motor terminals and the magnitude of the surge voltage, with the switching speed (rise time in turn-on: tr) varied as parameter. This result has been borrowed from the Journal of the Institute of Electrical Engineers of Japan, Vol. 107, Nov. 7, 1987. While the rise time in turn-on is 0.1˜0.3 μS for IGBT devices using conventional Si switching devices, the corresponding rise time for unipolar type SiC devices is less than 0.1 μS. Thus, the latter is faster than the former in switching. With this improved devices, therefore, the inverter and its load, i.e. motor, must be located close to each other.

The object of this invention is to provide an inverter apparatus which secures the reliability of motor winding insulation, with which a simple cooling mechanism can be used, and which can operate at relatively higher temperatures.

According to the inverter apparatus embodying this invention, the power module containing a plurality of switching devices operable at high temperatures is cooled by being attached to the housing for the transmission, the engine or the motor. Also, the inverter apparatus is provided with a soft switching circuit or a snubber circuit for suppressing surge voltages generated by the main inverter circuit.

According to this invention, the inverter can be operated at high temperatures while high reliability of motor winding insulation is being secured, and further the size of the inverter itself can be reduced.

Other objects, features and advantages of the invention will become apparent from the following description of the embodiments of the invention taken in conjunction with the accompanying drawings.

### BRIEF DESCRIPTION OF THE DRAWINGS

FIG. 1 schematically shows an inverter as a first embodiment of this invention, applied to a gasoline engine system used on an automobile;

FIG. 2 graphically shows the relationship between wiring conductor length vs. surge voltage, with switching speed varied as parameter;

FIG. 3 is a circuit diagram of an inverter as a second embodiment of this invention;

FIG. 4 is a circuit diagram of an inverter as second embodiment of this invention, wherein the soft switching circuit incorporated therein is depicted in detail;

FIG. 5 is a circuit diagram of an inverter as a third embodiment of this invention;

FIG. 6 is a circuit diagram of an inverter as a fourth embodiment of this invention;

FIG. 7 is a circuit diagram of an inverter as a fifth embodiment of this invention;

FIG. 8 schematically shows an inverter as a sixth embodiment of this invention, applied to a gasoline engine system used on an automobile; and

FIG. 9 schematically shows an inverter as a seventh embodiment of this invention, applied to a gasoline engine system used on an automobile;

### DESCRIPTION OF THE EMBODIMENTS

Embodiments of this invention will now be described in reference to the attached drawings.

### Embodiment 1

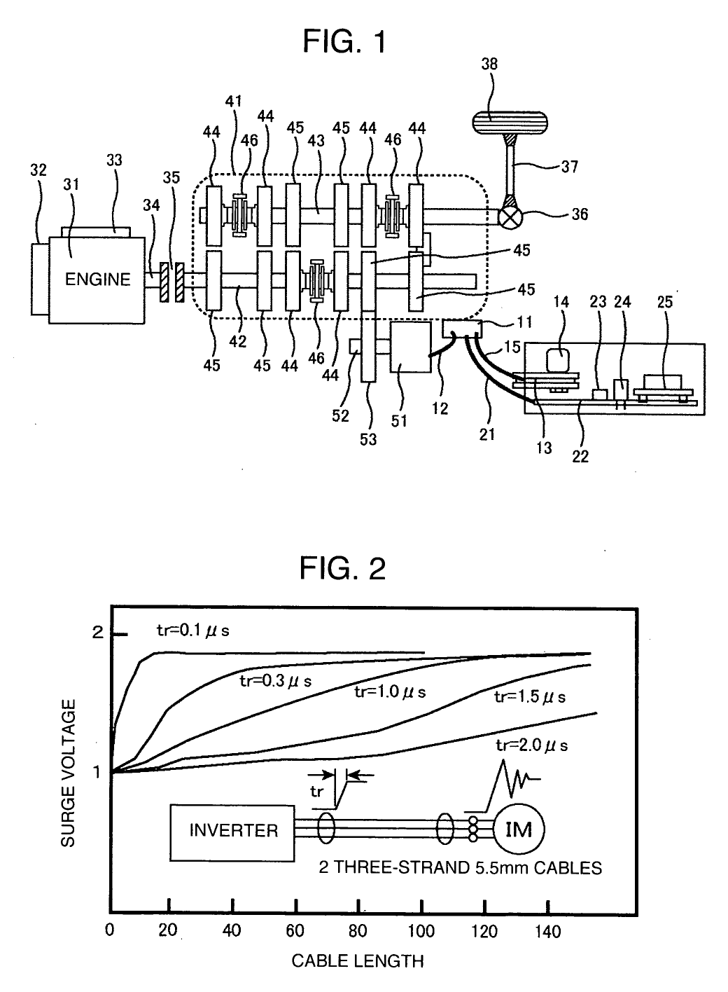

FIG. 1 shows the structure of a system to which an inverter as a first embodiment of this invention is applied. In FIG. 1, reference numeral 31 indicates an engine as a prime mover which is, for example, a water-cooled internal combustion engine such as a gasoline engine. A starter 32 serves to start the engine 31. The engine 31 has an air intake pipe in which an electronically controlled throttle 33 is installed to control the intake air flow. The fuel injector injects amount of fuel which suitably corresponds to the intake air flow. The signal representing the air-to-fuel ratio defined on the basis of the intake air flow and the amount of the fuel to be injected, and the signal representing the rotational speed of the engine, determine the ignition timing at which the ignition module causes the spark plugs to be fired.

A transmission 41 is provided with an input shaft 42 and an output shaft 43. The input shaft 42 of the transmission 41 is furnished with mesh type gears 44, gears 45 and a hub sleeve 46. The gears 45 are fixedly mounted on the input shaft 42 while the mesh type gears 44 are so mounted on the input shaft 42 as not to move in the axial direction of the input shaft 42. The hub sleeve 46 is mechanically coupled to the input shaft 42 by an engaging mechanism which can move in the axial direction of the input shaft 42 but which is restrained in the rotation about the input shaft 42. The output shaft 43 of the transmission 41 is furnished with mesh type gears 44, gears 45 and hub sleeves 46. The gears 45 are fixedly mounted on the output shaft 43 while the mesh type gears 44 are so mounted on the output shaft 43 as not to move in the axial direction of the output shaft 43. The hub sleeves 46 are mechanically coupled to the output shaft 43 by an engaging mechanism which can move in the axial direction of the output shaft 42 but which is restrained in the rotation about the output shaft 43. The gears on the input shaft 42 are engageable with the gears on the output shaft 43, and when the torque. generated by the engine is transmitted from the input shaft 42 to the output shaft 43, different transmission ratios can be achieved. Those ratios correspond to, for example, first speed gear through fifth speed gear and reverse gear.

A clutch 35 is interposed between the input shaft 42 and the crank shaft 34 of the engine 31. The engagement of the clutch 35 causes the driving force generated by the engine 31 to be transmitted from the crank shaft 35 to the input shaft 42. The disengagement of the clutch 35, on the other hand, breaks off the transmission of the driving force being transmitted from the engine 31 to the input shaft 42. This type of clutch 35 is widely used on various automobiles on which gasoline engines are installed. As the clutch 35 is engaged gradually, the automobile can be started. The same effect can be obtained if a torque converter is interposed between the engine 31 and the transmission 41. The output shaft 43 of the transmission 41 is provided with a final gear 36, and the final gear 36 is mechanically coupled to wheels 37 by a driving axle 38.

The output shaft 52 of a motor 51 has a gear 53 mounted fixedly thereon. The gear 53 is engaged with one of the gears 45 mounted on the input shaft 42 of the transmission 41. With this structure, the torque generated by the motor 51 can be transmitted to the input shaft 42. This motor 51 is an AC motor driven by a variable-voltage, variable-frequency, three-phase electric power.

In this embodiment, a power module 11, which incorporates therein a plurality of power semiconductor switching devices operable at high temperatures, is attached to the housing of the transmission 41 in contact with the outer surface thereof. The housing is filled with oil, and through the circulation of the oil is cooled the power module 11 which contains the power semiconductor switching devices operable at high temperatures. Moreover, since the power module 11 containing the power semiconductor switching devices operable at high temperatures is located near the motor 51, the wiring conductors 12 connecting the motor 51 with the power module 11 should be made short so that the surge voltages developed across the terminals of the motor 51 can be suppressed to a low level. Consequently, the high insulation of the motor windings can be secured. A smoothing capacitor 14 for smoothing rectified voltage and wiring conductors 15 connecting the smoothing capacitor 14 with the power module 11, constitute the main circuit for the power module 11. If the wiring conductors 15 between the smoothing capacitor 14 and the power module 11 is long, a surge voltage (ΔV) as given by the following expression (1) is generated at the time of switching taking place in the power module 11. Therefore, the length of the wiring conductors 15 should be made as short as possible.
ΔV=L(di/dt) (1)
where L indicates the inductance of the wiring conductors 15 between the smoothing capacitor 14 and the power module 11, and di/dt represents the change in current taking place when each of the power switching devices turns off.

Power semiconductor switching devices using SiC (silicon carbide), GaN (gallium nitride) or diamond, all of which are high temperature-resistive semiconductor materials, as their semiconductor substrates should preferably be used as the power semiconductor switching devices operable at high temperatures, contained in the power module 11. With these semiconductor materials, SiC (silicon carbide), GaN (gallium nitride) and diamond, the band gap energy is greater than that of Si (silicon), i.e. 2 eV (electron volts). In order to secure a highly reliable operation at high temperatures, a junction type transistor made of SiC which uses no gate oxide layer is most preferably recommended of all these wide band gap semiconductors.

The drive circuit for controlling the on/off operation of the power module 11 containing the power semiconductor switching devices operable at high temperatures, comprises such electronic parts as a control circuit PCB 22, a resistor 23, a capacitor 24 and a driver IC 25. Control signals and driving signals for the power module 11 containing the power semiconductor switching devices operable at high temperatures, are transmitted through wiring conductors 21 connecting the control circuit PCB 22 with the power module 11. As described above, according to this embodiment, the power module 11 is cooled by putting itself in contact with the housing of the transmission 41 while the drive circuit is located at a place which is separate from a high temperature zone and in a moderate temperature condition.

Thus, with this structure described above, this embodiment enables an inverter to be operated at high temperatures while highly reliable insulation of the windings of the motor driven by the inverter can be secured with the employment of a simple cooling system, with the result that the size of the inverter can be reduced.

### Embodiment 2

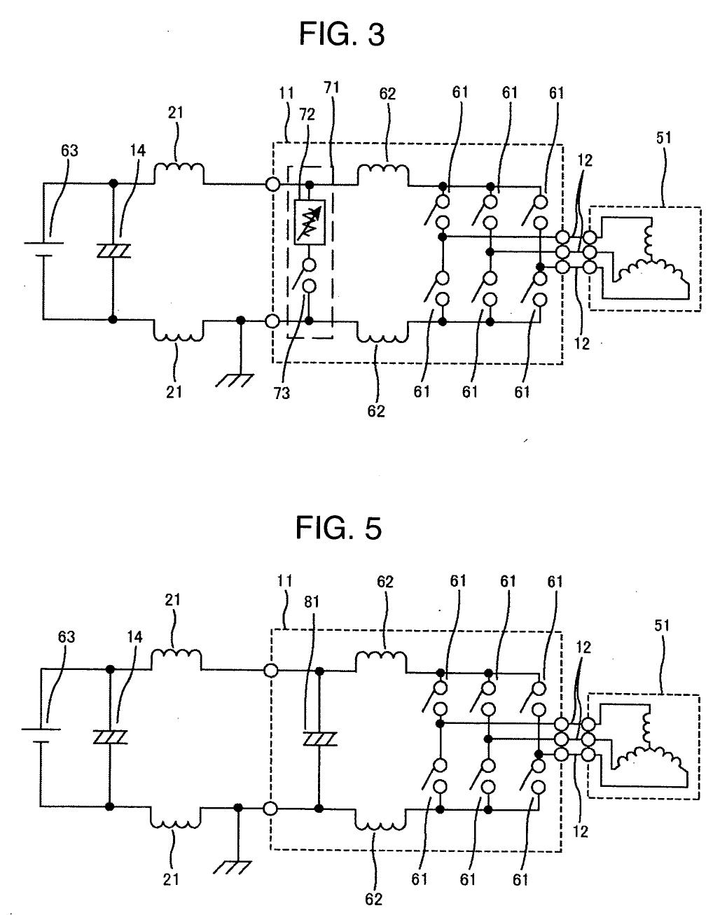

FIG. 3 is a circuit diagram of an inverter as a second embodiment of this invention. In FIG. 3, components equivalent to those shown with the first embodiment are indicated by the same reference numerals as in FIG. 1. A power module 11 containing a plurality of power semiconductor switching devices operable at high temperatures includes power semiconductor switching devices 61 operable at high temperatures. While the length of wiring conductors 12 between the power module 11 and a motor 51 is kept short, the length of wiring conductors 21 between the power module 11 and a capacitor 14 for smoothing a rectified voltage is left relatively long. Consequently, there is generated a surge voltage (ΔV) as given by the above expression (1), equated to the product of the inductance L of the wiring conductors 12 and the current reduction rate (di/dt) associated with the turning-off of the power semiconductor switching device 61.

In this second embodiment of the invention is provided a soft switching circuit 71 for suppressing this surge voltage. The soft switching circuit 71 comprises a switching device 73 for soft switching at high operating temperatures and a soft switching control circuit 72.

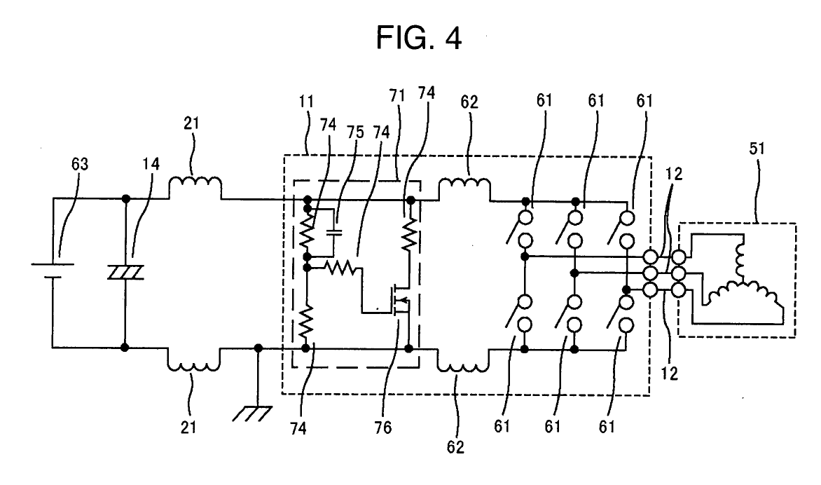

FIG. 4 shows the detail of the soft switching circuit 71 incorporated as a part in the power module 11 shown in FIG. 3. The soft switching circuit 71 comprises a switching device 76 for soft switching at high operating temperatures, resistors 74 and a capacitor 75. The switching device 76 for soft switching at high operating temperatures turns on in timing with the turn-off of the power semiconductor switching devices 61 so that the magnitude of the surge voltage is rendered low which is given by the product of the inductance L of the wiring conductors and the current reduction rate di/dt associated with the turn-off of the power semiconductor switching devices 61 operable at high temperatures. Thereafter, the switching device 76 for soft switching is softly turned off.

The provision of the soft switching circuit 71 enables the magnitude of the surge voltage to be rendered low which is given by the product of the inductance. L of the wiring conductors and the current reduction rate di/dt associated with the turn-off of the power semiconductor switching devices 61, and also the length of the wiring conductors 12 between the power module 11 and the motor 51 to be reduced, with the result that the surge voltages developed across the terminals of the motor 51 can be suppressed to a low level. With this embodiment, too, highly reliable insulation of the motor windings can be secured.

### Embodiment 3

FIG. 5 is a circuit diagram of an inverter as a third embodiment of this invention. In FIG. 5, again, components equivalent to those shown with the first and the second embodiments are indicated by the same reference numerals as in FIGS. 1 and 3. A power module 11 containing a plurality of power semiconductor switching devices operable at high temperatures, which is attached to the housing of the transmission in contact with the outer surface thereof, includes power semiconductor switching devices 61 operable at high temperatures. In this third embodiment of the invention, a snubber capacitor 81 is provided to suppress the surge voltage. Since the snubber capacitor 81 is located near or mounted within the power module 11, the surge voltage can be effectively suppressed. A ceramic capacitor or a film capacitor which has high resistances to high temperatures and vibrations should preferably be used as the snubber capacitor 81.

The provision of the snubber capacitor 81 enables the magnitude of the surge voltage to be rendered low which is given by the product of the inductance L of the wiring conductors and the current reduction rate di/dt associated with the turn-off of the power semiconductor switching devices 61, and the length of the wiring conductors 12 between the power. module 11 and the motor 51 to be reduced, with the result that the surge voltages developed across the terminals of the motor 51 can be suppressed to a low level. Accordingly, highly reliable insulation of the motor windings can be secured.

### Embodiment 4

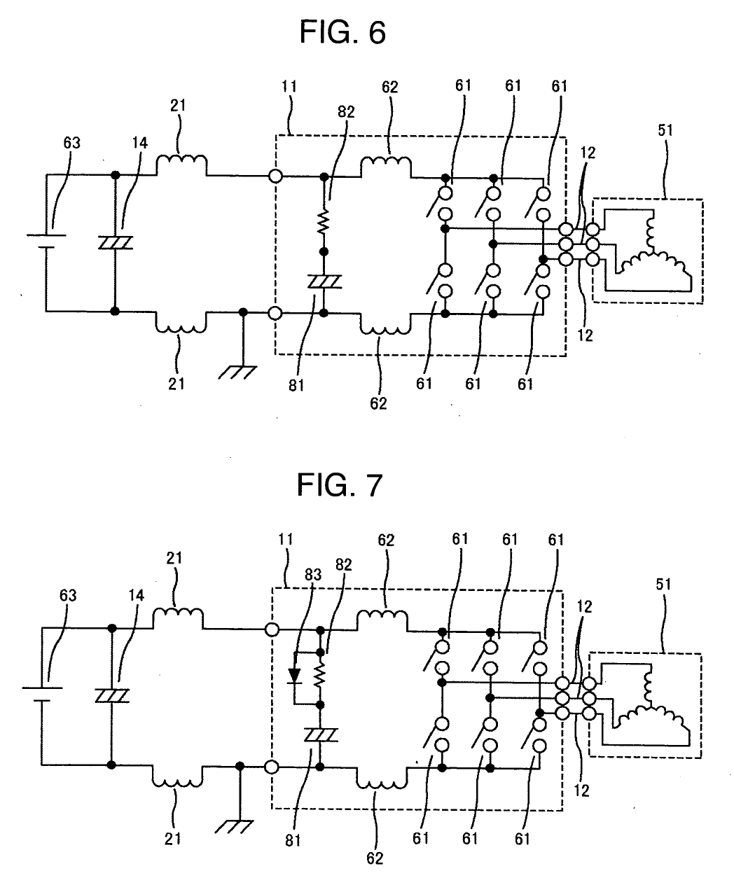

FIG. 6 is a circuit diagram of an inverter as a fourth embodiment of this invention. In FIG. 6, components equivalent to those shown with the first through third embodiments are indicated by the same reference numerals as in FIGS. 1, 3 and 5. In this embodiment, too, a power module 11 containing a plurality of power semiconductor switching devices operable at high temperatures, which is attached to the housing of the transmission in contact with the outer surface thereof, includes power semiconductor switching devices 61 operable at high temperatures. In this fourth embodiment of the invention, a snubber capacitor 81 and a snubber resistor 82 connected in series with the snubber capacitor 81 are provided to suppress the surge voltage. Since the snubber capacitor 81 and the snubber resistor 82 are located near or mounted within the power module 11, the surge voltage can be effectively suppressed. The snubber capacitor 81 and the snubber resistor 82 used in this embodiment should preferably have high resistance to both high temperatures and vibrations.

The provision of the snubber capacitor 81 and the snubber resistor 82 enables the magnitude of the surge voltage to be rendered low which is given by the product of the inductance L of the wiring conductors and the current reduction rate di/dt associated with the turn-off of the power semiconductor switching devices 61, and also the length of the wiring conductors 12 between the power module 11 and the motor 51 to be reduced, with the result that the surge voltages developed across the terminals of the motor 51 can be suppressed to a low level. Accordingly, highly reliable insulation of the motor windings can be secured.

### Embodiment 5

FIG. 7 is a circuit diagram of an inverter as a fifth embodiment of this invention. In FIG. 7, components equivalent to those shown with the first through fourth embodiments are indicated by the same reference numerals as in FIGS. 1, 3, 5 and 6. In this embodiment, too, a power module 11 containing a plurality of power semiconductor switching devices operable at high temperatures, which is attached to the housing of the transmission in contact with the outer surface thereof, includes power semiconductor switching devices 61 operable at high temperatures. In this fifth embodiment of the invention, a snubber capacitor 81, a snubber resistor 82 connected in series with the snubber capacitor 81 and a snubber diode 83 connected in shunt with the snubber resustor 82 are provided to suppress the surge voltage. Since the snubber capacitor 81, the snubber resistor 82 and the snubber diode are located near or mounted within the power module 11, the surge voltage can be effectively suppressed. The snubber capacitor 81, the snubber resistor 82 and the snubber diode used in this embodiment should preferably have high resistance to both high temperatures and vibrations.

The provision of the snubber capacitor 81, the snubber resistor 82 and the snubber diode 83 enables the magnitude of the surge voltage to be rendered low which is given by the product of the inductance L of the wiring conductors and the current reduction rate di/dt associated with the turn-off of the power semiconductor switching devices 61, and also the length of the wiring conductors 12 between the power module 11 and the motor 51 to be reduced, with the result that the surge voltages developed across the terminals of the motor 51 can be suppressed to a low level. Accordingly, highly reliable insulation of the motor windings can be secured.

### Embodiment 6

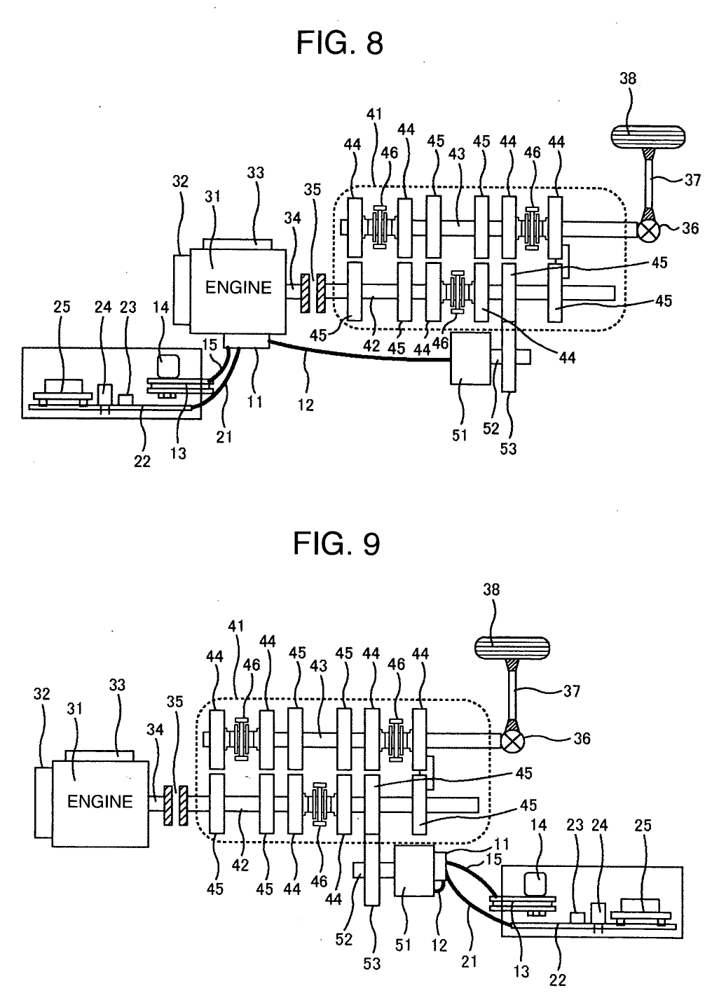

FIG. 8 shows the structure of a system to which an inverter as a seventh embodiment of this invention is applied. In FIG. 8, components equivalent to those shown with the first through fifth embodiments are indicated by the same reference numerals as in FIGS. 1, 3, 5, 6 and 7.

In this embodiment, a power module 11 containing a plurality of power semiconductor switching devices operable at high temperatures is attached to the body of the engine 31. The engine body 31 is cooled by cooling water. Through the circulation of the cooling water is cooled the power module 11 containing a plurality of power semiconductor switching devices operable at high temperatures. Since the power module 11 containing a plurality of power semiconductor switching devices is located near the motor 51, the length of the wiring conductors 12 between the power module 11 and the motor 51 can be reduced with the result that the surge voltage developed across the terminals of the motor 51 can be suppressed.

With this structure, while highly reliable insulation of the motor windings is secured, the inverter can be operated at high temperatures with a relatively simple cooling mechanism. Consequently, according to this embodiment, the size of the inverter can be reduced.

### Embodiment 7

FIG. 9 shows the structure of a system to which an inverter as a seventh embodiment of this invention is applied. In FIG. 9, components equivalent to those shown with the first through sixth embodiments are indicated by the same reference numerals as in FIGS. 1, 3, 5, 6, 7 and 8. In this embodiment, a power module 11 containing a plurality of power semiconductor switching devices operable at high temperatures is attached in contact with the outer surface of the housing of a motor 51 as an electric load. The motor housing is usually made of iron or aluminum which has a large heat capacity. The large heat capacity helps cool the power module 11 containing a plurality of power semiconductor switching devices operable at high temperatures. Also, since the power module 11 containing a plurality of power semiconductor switching devices operable at high temperatures is located near the motor 51, the length of the wiring conductors 12 between the power module 11 and the motor 51 can be reduced with the result that the surge voltage developed across the terminals of the motor 51 can be suppressed. With this structure, while highly reliable insulation of the motor windings is secured, the inverter can be operated at high temperatures with a simple cooling mechanism. Consequently, according to this embodiment, the size of the inverter can be reduced.

It should be further understood by those skilled in the art that although the foregoing description has been made on embodiments of the invention, the invention is not limited thereto and various changes and modifications may be made without departing from the spirit of the invention and the scope of the appended claims.

1. A power conversion apparatus comprising:
a smoothing capacitor for smoothing rectified voltage;
a power module containing a plurality of power semiconductor switching devices; and
a drive circuit for controlling the turn-on and turn-off of the power semiconductor switching devices, wherein
the power module is encased in a housing which does not contain the drive circuit and the housing encasing the power module is fixedly attached to another housing encasing the transmission of a prime mover.

2. A power conversion apparatus comprising:
a smoothing capacitor for smoothing an rectified voltage;
a power module containing a plurality of power semiconductor switching devices; and
a drive circuit for controlling the turn-on and turn-off of the power semiconductor switching devices, wherein
the power module is encased in a housing which does not contain the drive circuit and the housing encasing the power module is fixedly attached to another housing encasing a prime mover therein.

3. A power conversion apparatus as claimed in claim 2, wherein the housing encasing the prime mover therein is a body of a water-cooled engine.

4. A power conversion apparatus as claimed in claim 2, wherein the housing encasing the prime mover therein is a metal housing encasing an electric motor therein.

5. A power conversion apparatus comprising:
a smoothing capacitor for smoothing an rectified voltage;
a power module containing a plurality of power semiconductor switching devices; and
a drive circuit for controlling the turn-on and turn-off of the power semiconductor switching devices, wherein
each of the power semiconductor switching devices contained in the power module is a wide-band-gap semiconductor device having an energy band gap equal to or greater than 2 eV, the power module is encased in a housing which does not contain the drive circuit, and the housing encasing the power module therein is fixedly attached to one of a housing encasing a prime mover therein and a housing encasing the transmission of the prime mover therein.

6. A power conversion apparatus as claimed in claim 5, wherein the wide-band-gap semiconductor device is a semiconductor device having its semiconductor substrate made of SiC, GaN or diamond.

7. A power conversion apparatus as claimed in claim 5, wherein the wide-band-gap semiconductor device is a junction type FET.

8. A power conversion apparatus as claimed in claim 5, wherein the power module includes a soft switching circuit, and the soft switching circuit includes the series connection of a semiconductor switching device and a resistor, and a control circuit for controlling the semiconductor switching device.

9. A power conversion apparatus as claimed in claim 5, wherein the power input terminals of the power module is provided with a snubber circuit.

10. A power conversion apparatus as claimed in claim 9, wherein the snubber circuit connected across the power input terminals of the power module consists of a capacitor and a resistor connected in series with each other.

11. A power conversion apparatus as claimed in claim 10, wherein a diode is connected in shunt with the resistor of the snubber circuit connected across the power input terminals of the mower module.
